(19) United States
(12) Patent Application Publication
(10) Pub. No.: US 2011/0308523 A1
(43) Pub. Date: Dec. 22, 2011

(54) AIR ON DEMAND BREATHING SYSTEM USING A DYNAMIC TRANSDUCER FOR CONTROLLING AIR

(76) Inventors: ROBERT MANUEL CARMICHAEL, FORT LAUDERDALE, FL (US); IULIUS VIVANT DUTU, BOCA RATON, FL (US)

(21) Appl. No.: 13/072,532

(22) Filed: Mar. 25, 2011

Related U.S. Application Data
(63) Continuation of application No. 13/048,843, filed on Mar. 15, 2011.
(60) Provisional application No. 61/317,685, filed on Mar. 25, 2010.

(51) Int. Cl. A62B 7/00; H01M 2/10

(52) U.S. Cl. 128/204.21; 429/99

(57) ABSTRACT

An air on demand breathing system using a dynamic transducer for controlling air is disclosed. As the compressor of the system only provides air within the hose line when a threshold has been reached as determined by the dynamic transducer battery consumption is extended as the battery does not have to provide power to the system at all times. A novel removal and replacement configuration for the one or more batteries of the system is also described.

This application claims the benefit of and priority to U.S. Patent Application Ser. No. 61/317,685, filed Mar. 25, 2010, and is a continuation-in-part of U.S. patent application Ser. No. 13/048,843, Filed Mar. 15, 2011, both applications are incorporated by reference in their entirety.

### FIELD OF THE INVENTION

The present invention relates generally to underwater breathing apparatuses, and specifically to an underwater breathing apparatus which includes a controller and compressor for providing air on demand and which permits the control of the speed of compressor based on the pressure and air volume provided by the compressor and the air used by the one or more divers using the underwater breathing apparatus and which is provided with removable batteries in one or more embodiments.

### BACKGROUND OF THE INVENTION

Surface located breathing apparatuses which provide air to underwater divers through a connected hose have been in existence for many years. These breathing apparatuses typically use an electric motor requiring a battery or electric engine requiring fuel. Therefore, the breathing apparatus has a relatively short time period before the battery is all used up or the engine requires more fuel. The present invention is directed to extending the time period between battery replacement or fuel replenishment through the incorporation and use of novel dynamic transducer as part of breathing apparatus technology. The present invention also provides a novel battery connection and which provides for battery removal in the no

### SUMMARY OF THE INVENTION

In a preferred embodiment, the present invention can provide an underwater breathing apparatus that can include an electric motor or engine, coupled to a compressor means for compressing the ambient air, and a controller in connection with the motor (engine) to control the function of the compressor. A mouth piece is coupled to the stored air within the hoses produced by the compressor for use by the diver using the underwater breathing apparatus. Multiple divers can be connected to the underwater breathing apparatus at the same time, with each diver having his or her own mouthpiece and associated air hose line. The system further contains a power source means for providing power to the compressor means, and to a control circuit means for controlling some of the various functions of the present invention.

In various embodiments, the system can have a compressor powered by an electric motor, gas or diesel engine (all collectively referred to as “power propulsion”), a controller in connection with the power propulsion. The compressor can produce breathing air at a variable spin of the power propulsion. Through the use of a dynamic sensor and pressure switch, the system does not constantly run at all times, and therefore helps to conserve the battery life or the amount of combustible, since the motor is basically stalled at startup and at other times when there is sufficient amount of stored air. The controller can monitor the output pressure and the volume of air (cubic feet per minute—CFM) of the compressor assembly and can adjust the speed of the power propulsion to keep the right pressure available to the mouthpiece based on the air demands of the user(s).

Other benefits of the invention include, but are not limited to, the control of the speed (spinning) of the motor (compressor) to a variable rate, based on the user's needs for more air, conserving the life Of the battery or the amount of combustible.

Also disclose are novel configurations for battery removal and replacements.

### BRIEF DESCRIPTION OF THE DRAWINGS

FIG. 1 consists of several drawings of the magnetic sensor with Hall Effect in accordance with the present invention;

FIG. 2 is a block diagram of an underwater breathing apparatus incorporating the magnetic sensor of FIG. 1;

FIG. 3 is a graph illustrating certain design characteristics of the underwater breathing apparatus of FIG. 2;

FIG. 4 is a perspective view of the magnetic sensor with Hall Effect in accordance with the present invention;

FIG. 5 is an exploded view of another embodiment for the sensor with Hall Effect in accordance with the present invention;

FIG. 5 is a block electrical diagram of an air-on-demand system uses a variable dynamic sensor in accordance with the present invention;

FIG. 6 is a block electrical diagram for one embodiment of connecting two batteries two each other in accordance with the present invention;

FIG. 7 shows in perspective the batteries and battery connection/bridge in accordance with the present invention preferably used with the present invention air-on-demand system;

FIG. 8 shows a perspective view of one of the battery terminal contacts in accordance with the battery connection/bridge shown in FIG. 7;

FIG. 9 shows a perspective of an inflatable device which can be used with the present invention air-on-demand system particularly for floating the air-on-demand system on the surface of a body of water;

FIG. 10 shows another perspective view of the batteries and battery connection/bridge of FIG. 7;

FIG. 11 is a perspective view illustrating a housing or pan for holding or containing the present invention air-on-demand system of the present invention and also illustrating the receiving area for the batteries;

FIG. 12 is a perspective view of the cylinder/housing for one of the battery terminal contacts of FIG. 8;

FIG. 13 is another perspective view of one of the battery terminal contacts of FIG. 7 and also showing the starboard aperture used for securing the battery terminal contact to the starboard;

FIG. 14 is a block electrical diagram of an air-on-demand system which uses a variable dynamic sensor with integrated pressure switch.

FIG. 15 is a block diagram of an underwater breathing apparatus incorporating the magnetic sensor with pressure switch;

FIG. 16 consists of several drawings of the magnetic sensor with Hall Effect in accordance with the present invention including the pressure switch incorporated as one part of the sensor embodiment;

FIG. 17 consist of an alternative way to power the unit using a AC/DC power supply in a novel custom construction (design) witch will fit in the space/place of the batteries and can connect to the unit using the spring loaded contacts illustrated in the drawings/images;

FIG. 18 is a further way of designing the electrical connection;

FIGS. 19-22 illustrate a preferred embodiment for the present invention assembly/system;

FIG. 23 is perspective view of a handle in accordance with the present invention for easier removal of the battery or batteries components of the present invention assembly/system; and

FIG. 24 is a perspective view of the handle of FIG. 23 shown secured to the top of a battery in accordance with the present invention assembly/system.

### DETAILED DESCRIPTION OF THE INVENTION

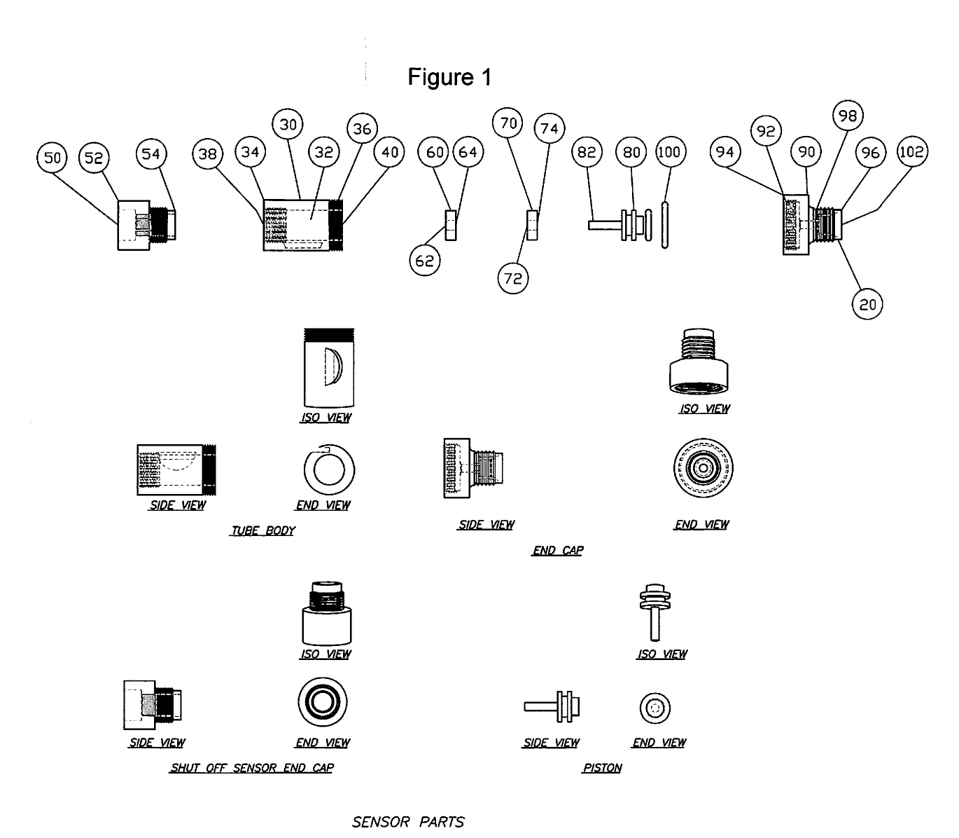

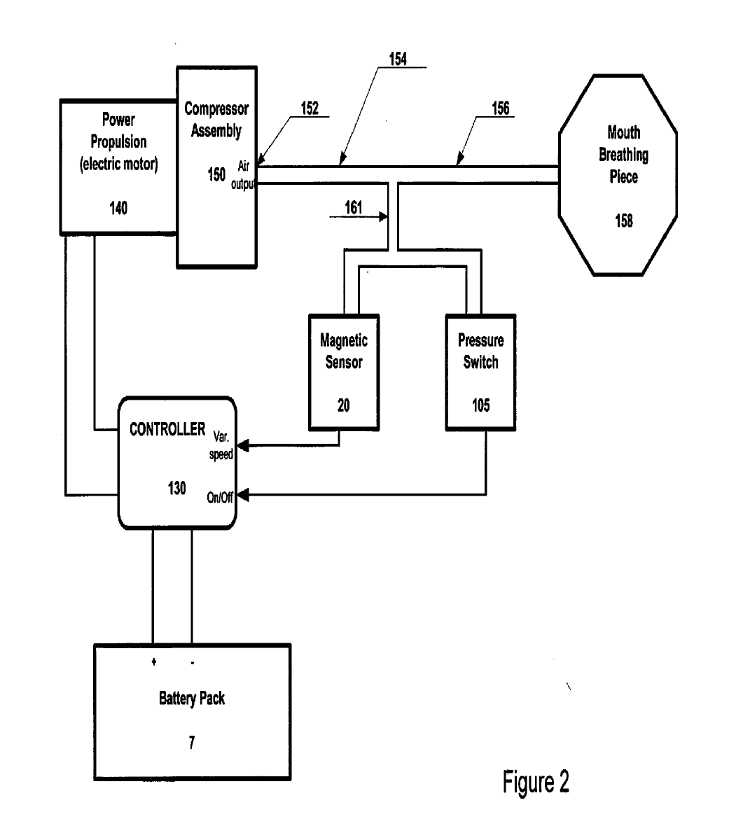

As seen in FIG. 1, the variable speed transducer of the present invention is shown in several views and in a preferred embodiment can be and is generally designated as variable dynamic sensor 20. Preferably, sensor 20 can be a variable speed Hall Effect magnetic sensor, though such is not considered limiting. The use of a transducer or sensor provides a device that converts one type of energy into another form of energy. With the present invention the transducer allows for the conversion of pressure to electricity, preferably through the use of a magnetic field and Hall Effect described in more detail below.

The continuous-time ratio metric output voltage can be set by the supply voltage. It can vary in proportion to the strength of the magnetic field. The air produced can move the magnet in face of the Hall effect IC and set up the output voltage which can be read by the controller for determining how much to increase or decrease the motor's power.

Sensor 20 can include a housing or cylinder 30 having an internal passageway 32 therethrough extending from a first side 34 to a second side 36. The end of passageway 32 associated with first side 34 can be preferably provided internal threads 38 and the external surface of cylinder 30 adjacent second 36 can be preferably provided with external threads 40.

The sensor can be immune to dust, dirt, mud, and water. These characteristics make Hall Effect devices better for position sensing than alternative means such as optical and electromechanical sensing.

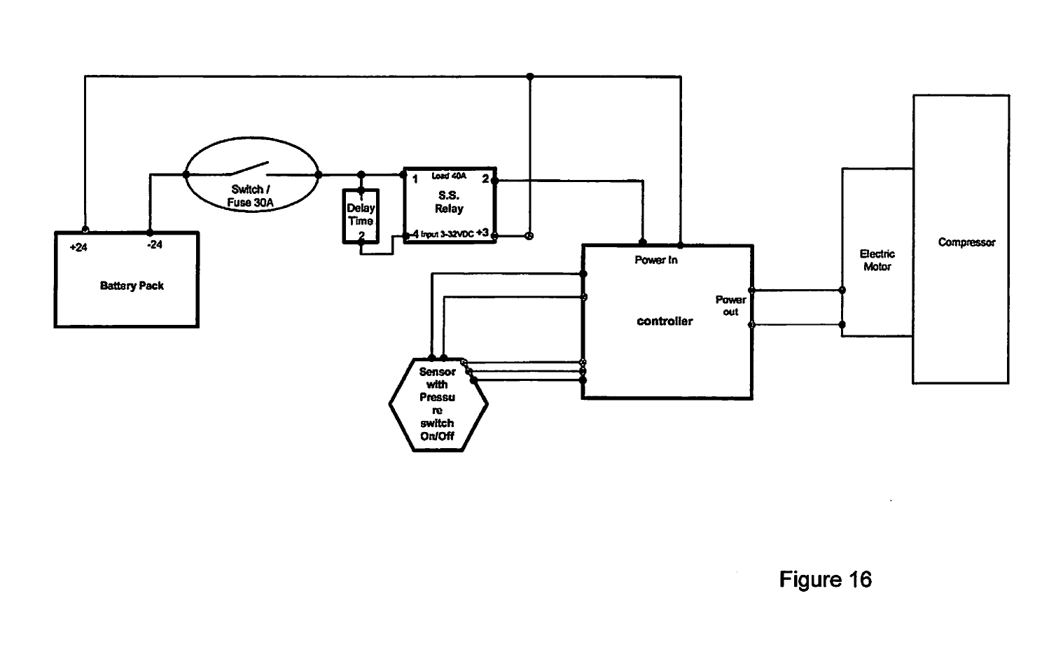

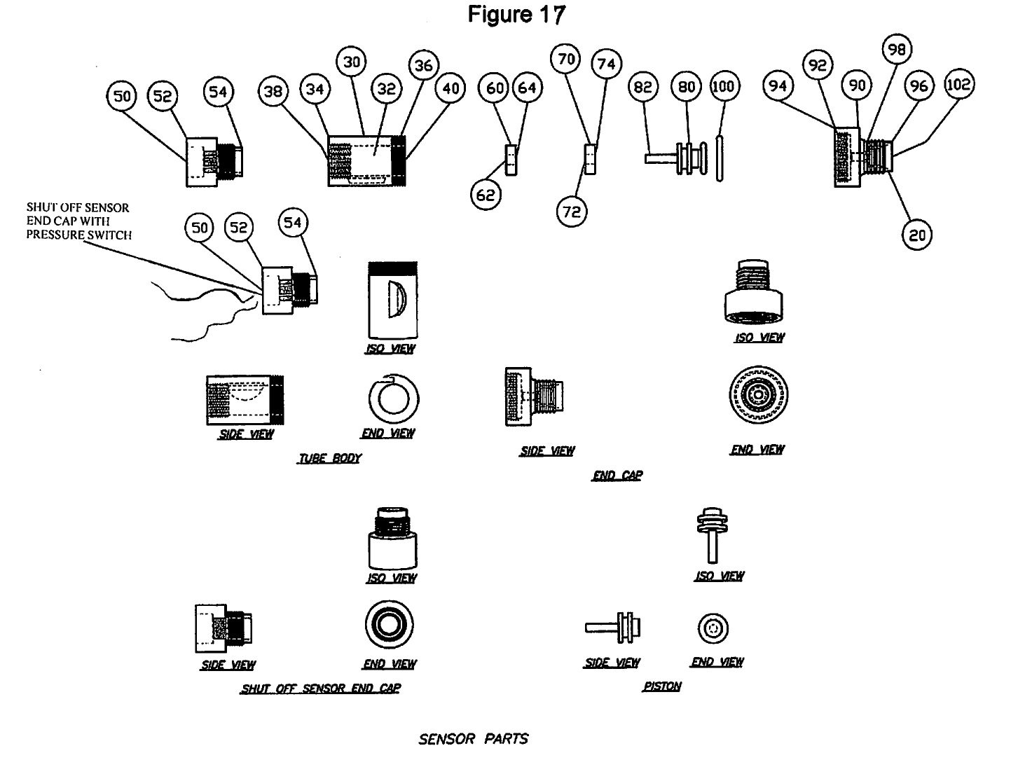

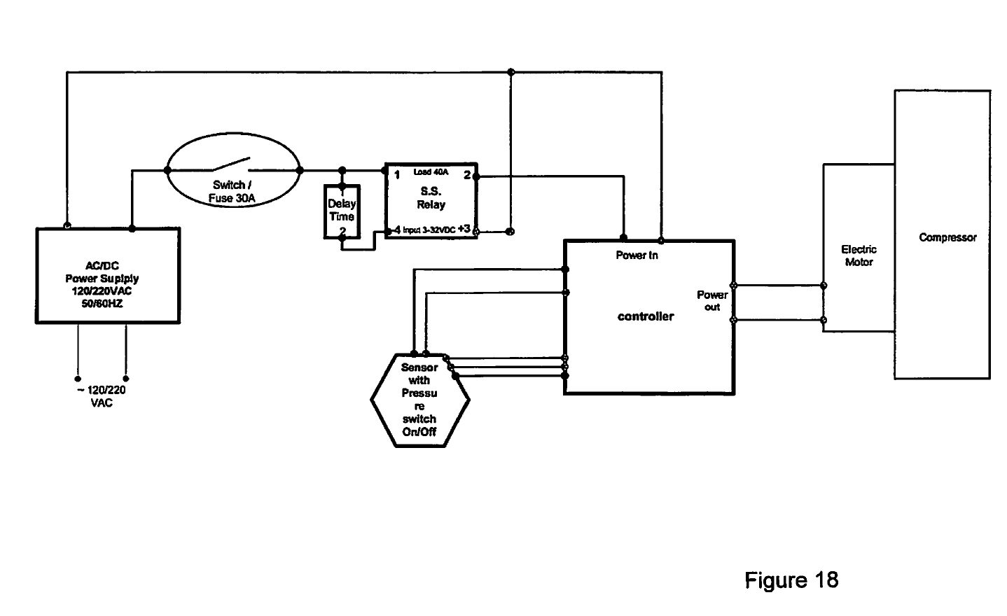

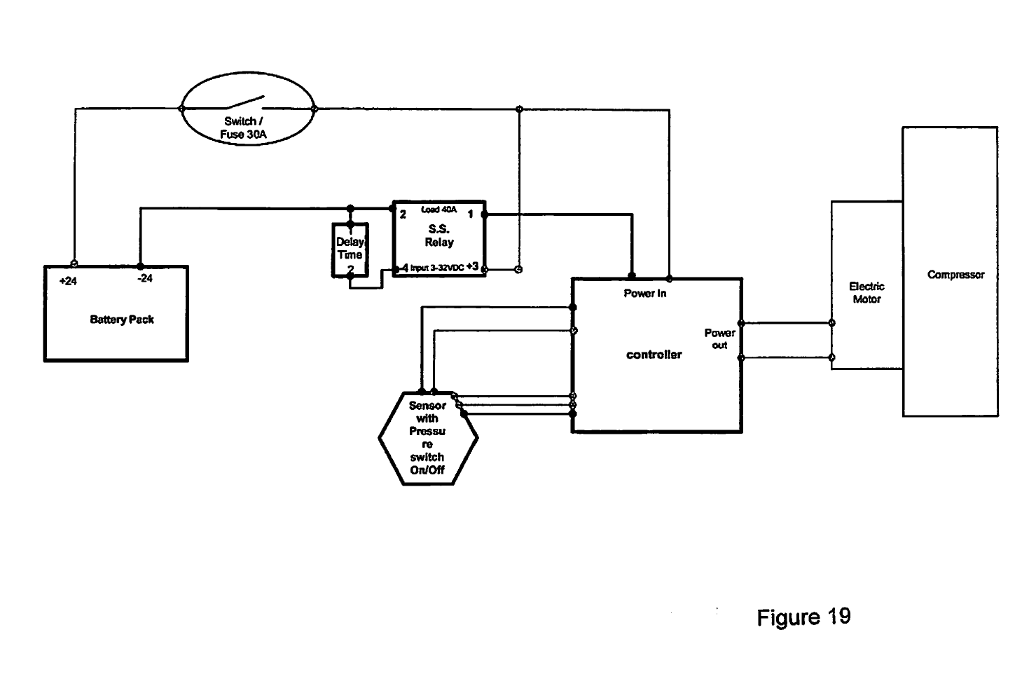

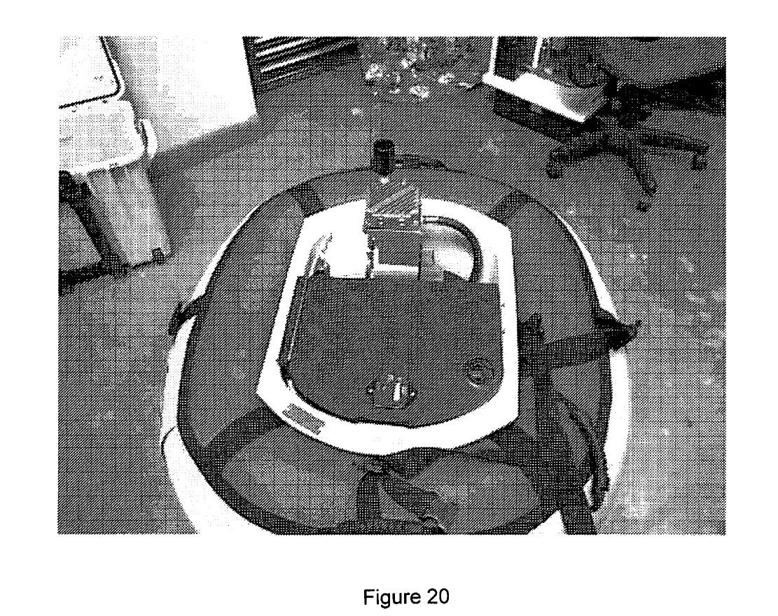

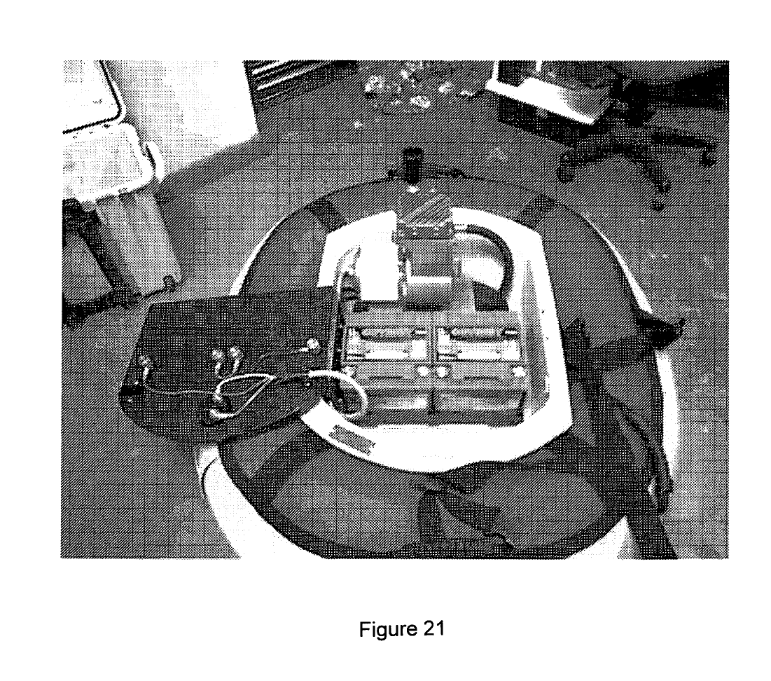

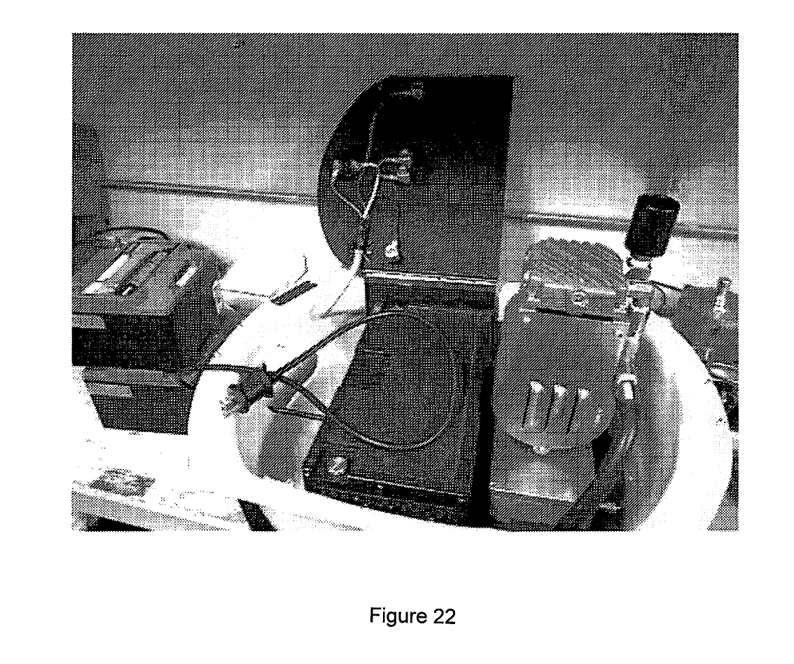

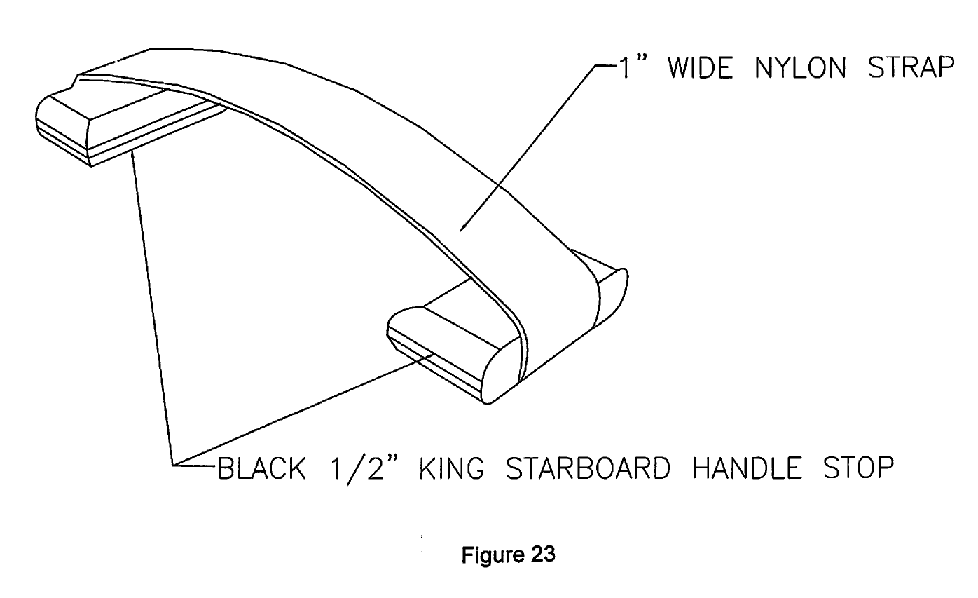

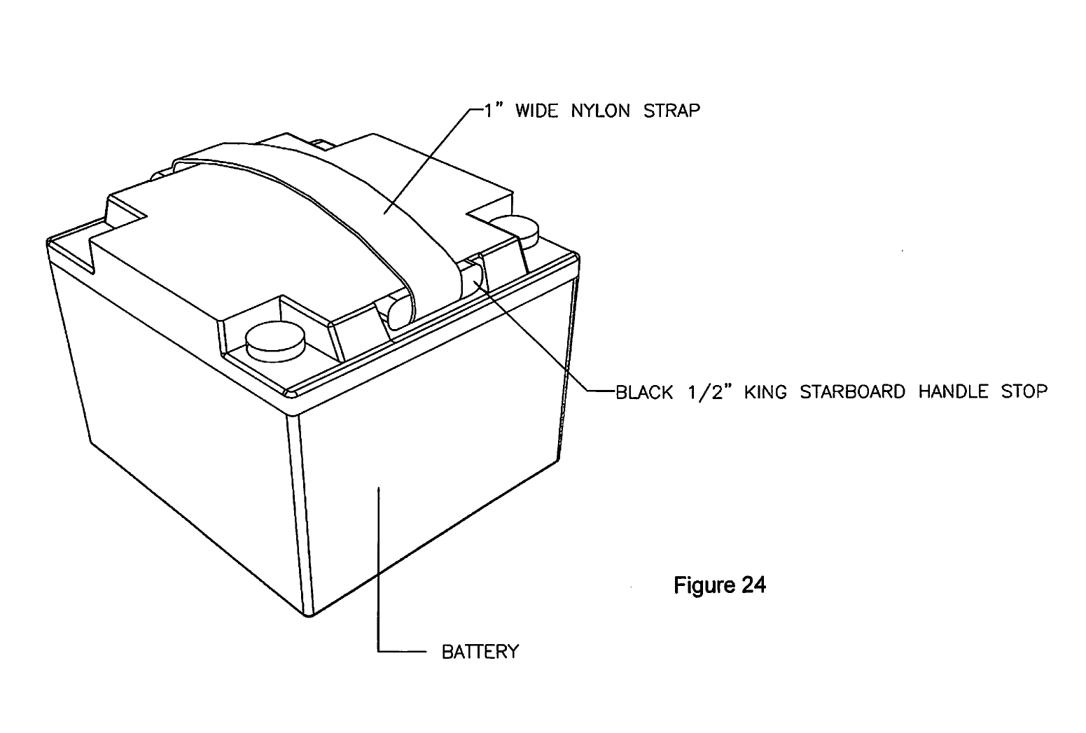

A first end cap 50 can be adjustable and can be screwed in and can be considered the fixed magnet positioned close to the mobile or movable magnet, increasing the force between the magnets. In this way the mobile magnet will be more in front of the IC (hall effect) and will give more amperes to the motor at the end point before it will turn off at preferably, approximately 60 p.s.i., though such value is not considered limiting. Where end cap 50 is rotated in an opposite direction (screwed out), the force between the magnets will decrease and the motor will get less power to the end point. The adjustable end cap will affect simultaneous and direct proportional with the above description of the “start” power consumption from the end point (then the motor will be turn on by the pressure switch. End cap 50 can have external threads 52 is secured at first side 34 of cylinder 30 by the mating of external threads 52 with internal threads 38 located within passageway 32. End 54 of first end cap 50 can be incorporated with a pressure switch in same sensor; and can have attached at 54 a tactile switch as show in FIG. 16 (i.e. sealed construction or better, but not limited to). The pressure switch can be actuated by the rod part 82 of the piston 80. It's functionality can be to turn ON/OFF the motor at a preset pressure (e.g. about 60 psi) in direct relation with the force between the magnets and air pressure applied to piston cap 80. End 54 of end cap is preferably disposed within passageway 32 when end cap 50 is secured to cylinder 30, acts as a stop member for a first magnet 60 that is disposed within passageway 32, whose purpose will be discussed below. First magnet 60 has a first side 62 having a first polarity (either + or −) and a second side 64 having an opposite polarity to the polarity of first side 62. A second magnet 70 is also disposed within passageway 32 and has a first side 72 having a first polarity and a second side 74 having opposite polarity to the polarity of first side 72. As a non-limiting example, the polarity of first side 62 of magnet 60 and the polarity of first side 72 of magnet 70 can be the same and the polarity of second side 64 of magnet 60 and the polarity of second side 74 of magnet 70 can be the same.

Where first side 62 of magnet 60 abuts end cap 50, then magnet 70 is positioned within passageway 32 such that second side 74 of magnet 70 is closest to magnet 60. Where second side 64 of magnet 60 abuts end cap 50, then magnet 70 is positioned within passageway 32 such that first side 72 of magnet 70 is closest to magnet 60. In either configuration the polarity of the sides of magnet 60 and 70 closest to each other are the same, such that magnets 60 and 70 are not attracted to each other and naturally repel each other. The repelling force of magnet 70 towards magnet 60 in conjunction with the fixed position of end 54 of first end cap 50 causes magnet 60 to remain in a fixed position abutting end 54 virtually at all times during operation.

A piston or plunger or other movable member (collectively referred to as “piston 80”) is at least partially positioned and movable within passageway 32 for moving magnet 70 within passageway 32 as will be discussed in detail below. Piston 80 has a rod 82 or other contact member which contacts one of the sides of magnet 70. This contact between rod 82 and magnet 70 remains virtually at all times during operation in view of magnet 60 and magnet 70 naturally repelling each other as discussed above.

A second end cap 90 having internal threads 92 at a first end 94 is secured to second side 46 of cylinder 30 by the mating of external threads 40 of cylinder 30 with the internal threads 92 of second end cap 90. The opposite end 96 of second end cap 90 is provided with external threads 98 for mating with a hose line (not shown) or any other conduit used for transporting air from a compressor, which will be discussed in more detail below. An o-ring 100 or other sealing device (i.e. gasket, etc.) can be disposed within second end cap to help prevent leakage of air. A passageway 102 is provided within second end cap 90 from first end 94 to second end 94 to permit air traveling through the hose attached to second end 98 to enter second end cap and contact piston 80, the purpose of which will be discussed in more detail below.

A cutout can be provided in the surface of cylinder 30, for receipt of a magnetic sensing element, preferably in the form of an integrated chip though such is not considered limiting, which senses the movement of magnet 70 within passageway 32. A pressure switch 105 can be provided and is in communication with hose line 161 that is secured to second end 96 of second end cap 90 and is in communication with a controller 130 used to control the operation of a power propulsion device (i.e. electric motor, etc.) 140 of a compressor assembly 150. Pressure switch 105 serves as an on/off switch for controller 130 and magnetic sensor 20 serves as a speed control which determines how fast to run power propulsion 140/compression assembly 150 when pressure switch 105 is closed, which causes controller 130 to be “on”.

Compressor assembly 150 for generating breathable air has an outlet 152 having an air hose line 154 (or other conduit) connected thereto. The single inlet of a splitting manifold, such as, but not limited to, a “T” or “Y” can be connected the opposite end of the hose line. A second hose line 156 is connected at one end to the first outlet of the splitting manifold and at its second end to a mouthpiece worn 158 by the user requiring breathable air (i.e. underwater user, etc.). A third hose line 161 is connect at one to the second outlet of the splitting manifold and at its second is secured to second end 96 of second end cap 90, as described above.

Virtually at the moment air is added to the hose lines by compressor 150, air pressure is built up within the second hose line connected to the mouthpiece and also within the third hose line connected to second end cap 90. In view of passageway 102 of second end cap 90, the air pressure in the third hose line is permitted to push upon piston 80 (i.e. input to piston 80) which will provide sufficient force (i.e. enough to overcome the natural repelling force between magnets 60 and 70) to allow piston 80 to move magnet 70 closer to magnet 60. Thus, magnet 70 moves with the movement of piston 80. As will be described below, the movement and position of magnet 70 as read by the magnetic sensing element located in the cutout of cylinder 30 will determine whether to increase or decrease the speed of power propulsion 140, when pressure switch 105 is in closed position and controller 130 is “on”. A variation of the magnetic field caused by the movement of magnet 70, translates into a variation of voltage provided by controller 130. The variation in voltage from controller 130 determines whether power propulsion 140 will be driven with high rpm or low rpm.

In use, prior to the user breathing from mouthpiece, pressure in the hose lines is at a maximum, providing piston 80 with sufficient force to push or move magnet 70 closest to magnet 60. In one embodiment this pressure can be anywhere from about 50 psi to about 65 psi, and preferably about 55 psi. Pressure switch 105 is set such that when the set pressure reading (i.e. about 65 psi, etc.) is reached, pressure switch 105 opens to turn off controller 130, since air within the hose lines is at a maximum, thus, there is no need to run compressor assembly 150, since there is no need for additional air. As compressor assembly 150 is not running at all times during use, power consumption is conserved, allowing the air on demand breathing device to operate at a longer period of time.

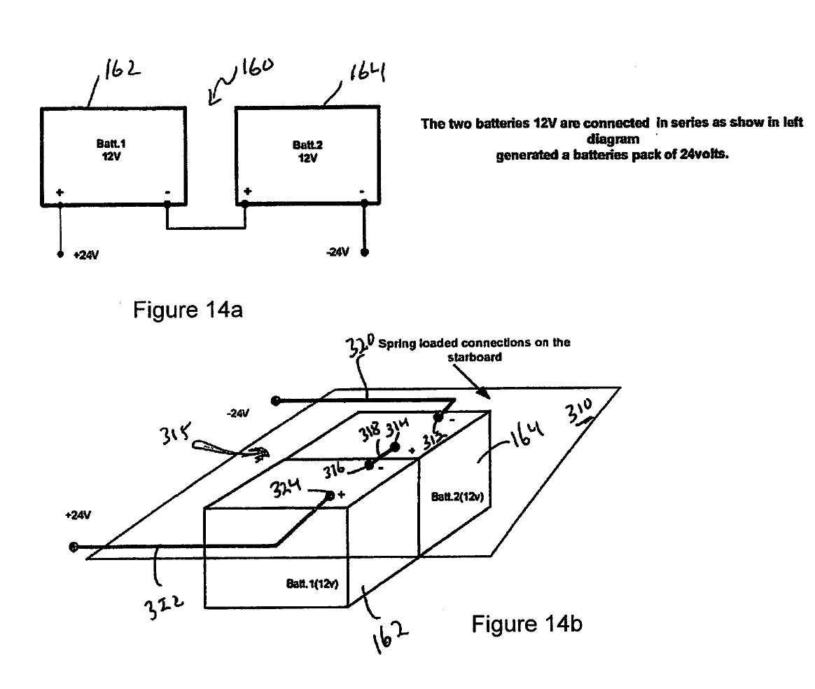

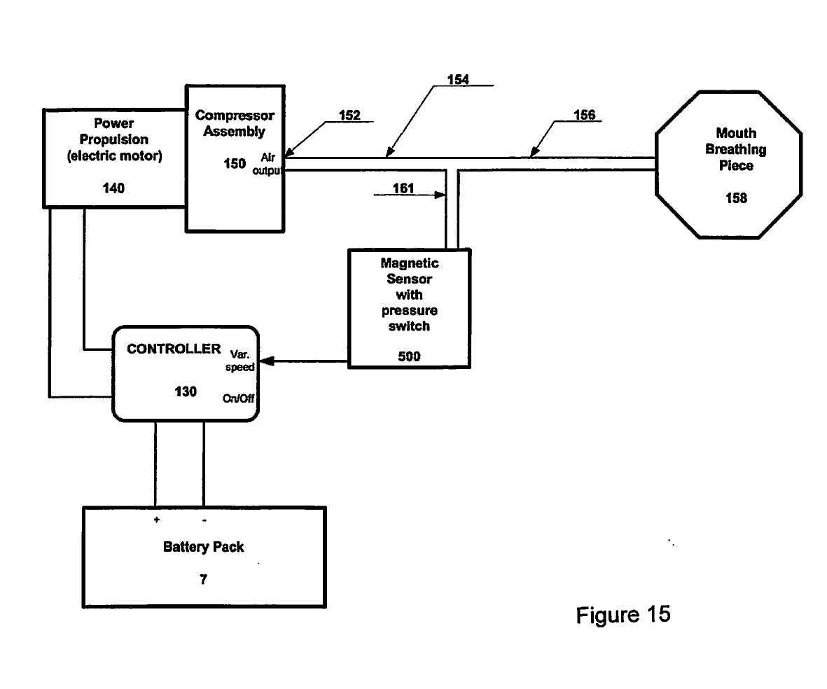

The same functionality and description described made for pressure switch 105 can be applicable when using a compilation sensor (magnetic and pressure switch) 500 (see FIG. 14). This provides for a dynamic compilation sensor controlling the rotation of the motor and the turning ON/OFF of the motor, which with this novel sensor can create a lot of advantage.

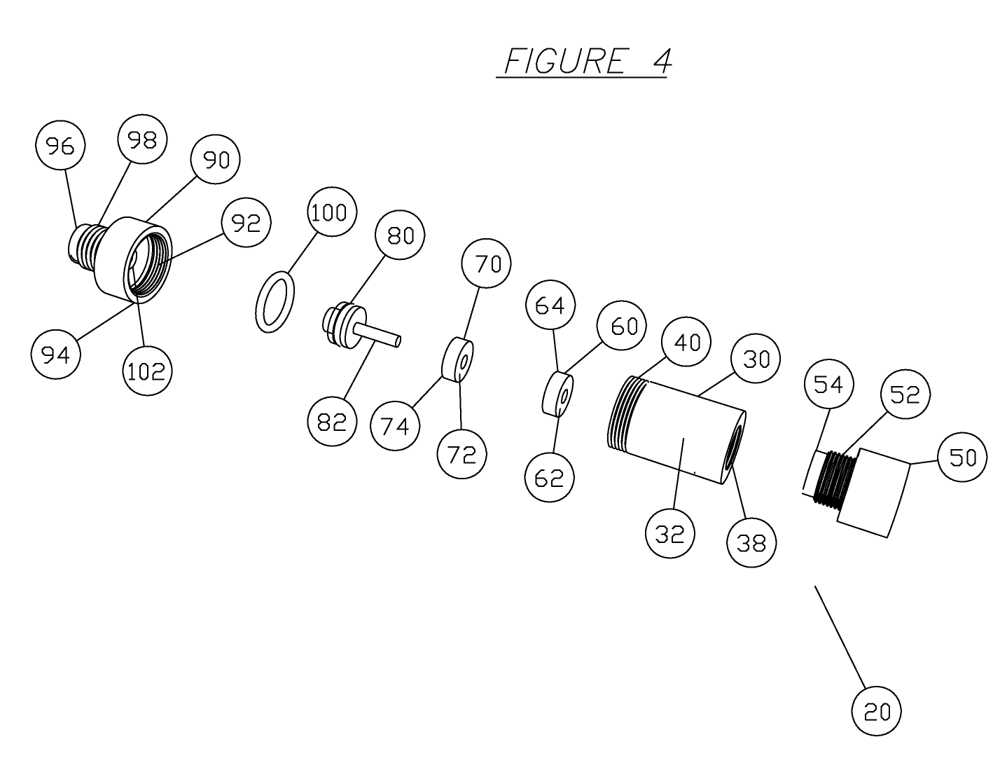

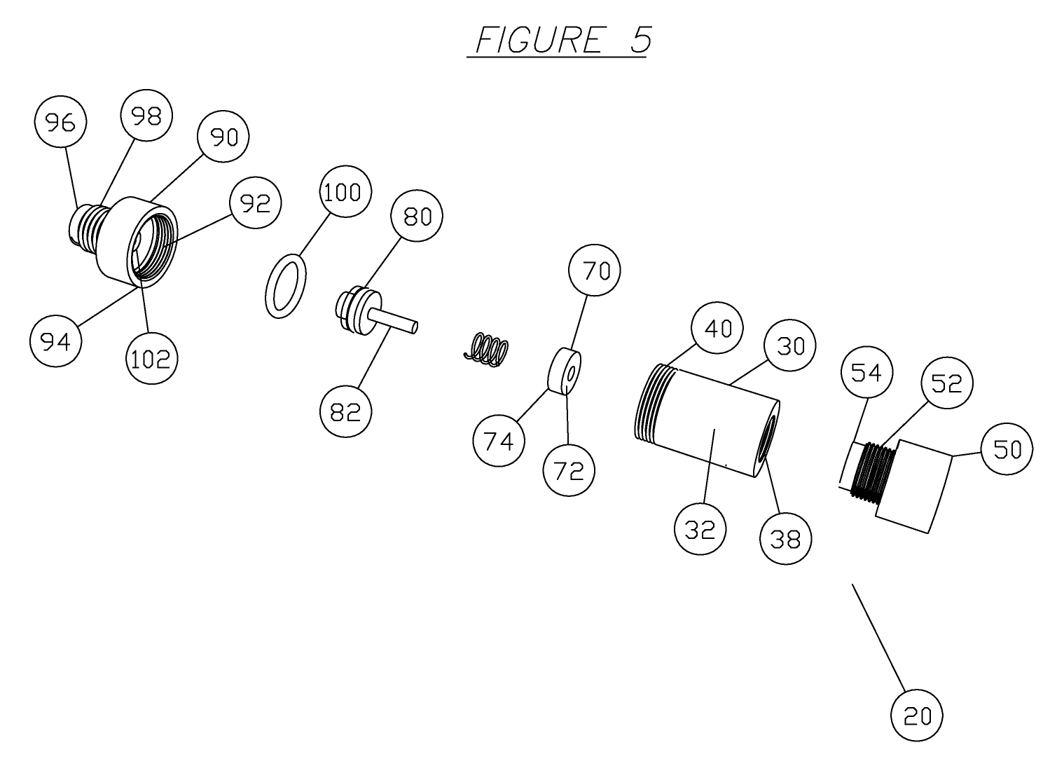

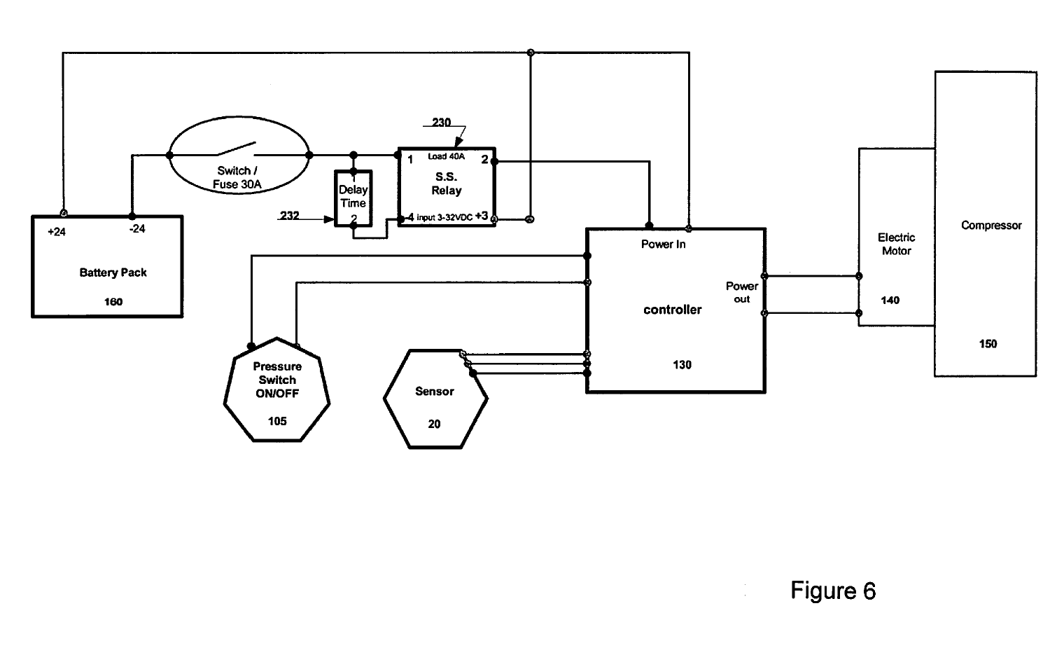

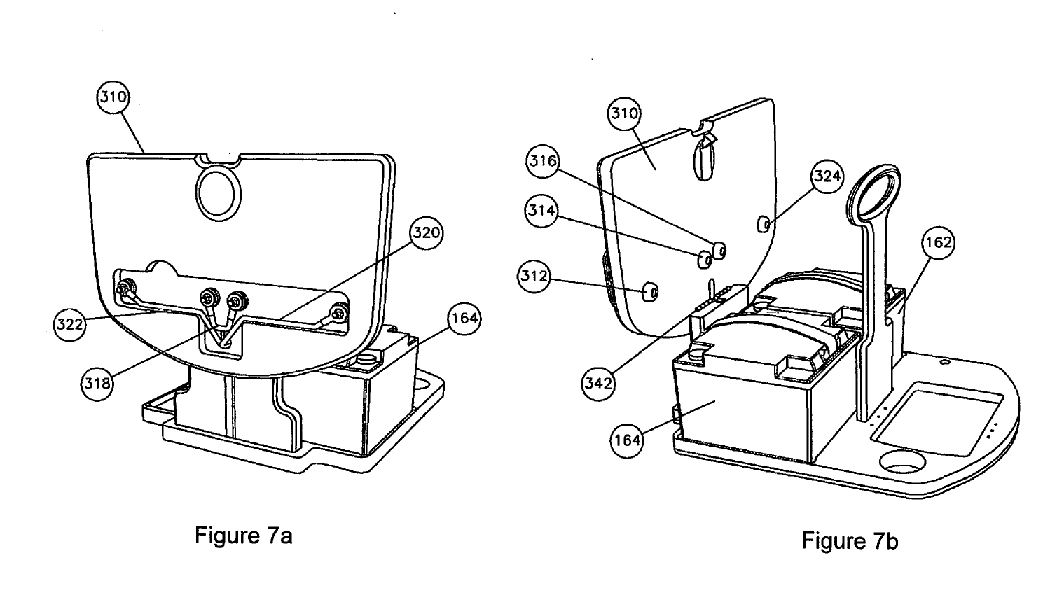

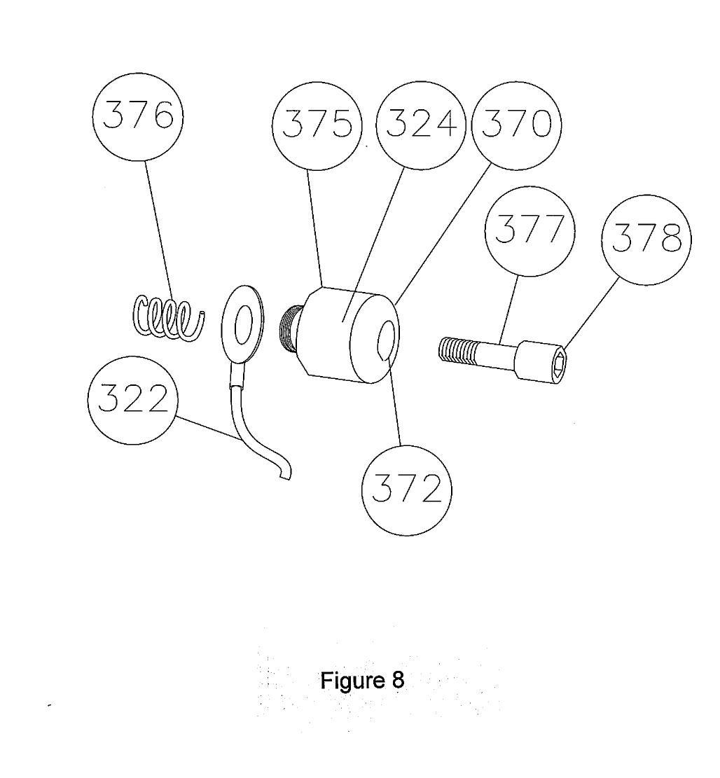

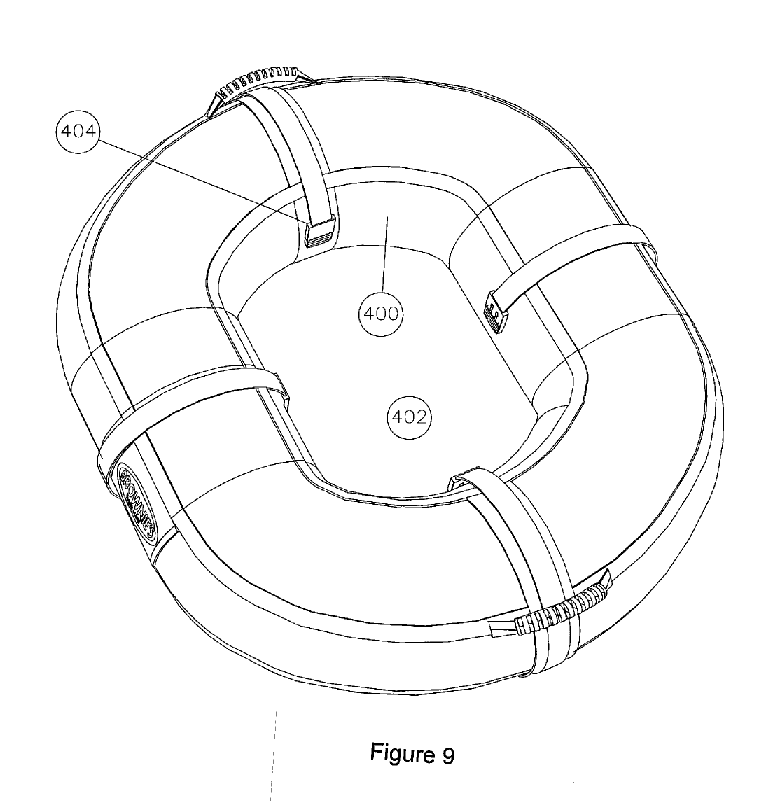

With the present invention described above and below, the functionality can have a direct relation of the force between the magnets, magnet and a compression spring (FIG. 5), or a magnet and pyrolytic graphite and the air pressure applied to piston cap 80 actuating the pressure switch by rod 82 (See FIG. 4 and/or FIG. 16).

The present invention provides for more ergonomic size, is easy to connect and takes up less space.

The dimension of the sensor can be the same.

As the user breathes through mouthpiece 158 air is removed from within the hose lines, which causes the pressure to drop and once the pressure drops below the selected threshold (i.e. about 55 psi, etc.), pressure switch 105 closes causing controller to be turned “on”. The reduction of air pressure in the hose lines, also reduces the force being provided by piston 80 against magnet 70, thus permitting magnet 70 to move away from magnet 60 (in view of the repelling forces between the magnets). The sensing element senses this movement and sends a signal to controller 130 to increase the speed of power propulsion 140/compressor 150 to generate and release more air into the hose lines through outlet 152. The further apart magnet 70 is from magnet 60 correspondingly increases the speed of power propulsion 140/compressor 150. At a certain point, the air outputted into the hose lines from compressor 150, will cause the pressure (pounds per square inch—psi) in the hose lines to increase which causes piston 80 to create more force to move magnet 70 closer to magnet 60, which in turn reduces the speed of power propulsion 140/compressor 150. Also, once the increase in pressure within the hose lines exceeds the selected threshold (i.e. about 55 psi, etc.), pressure switch 105 will open or (close), which turns off controller 130, and thus conserves the energy from battery pack 160, to permit it last longer in duration in use. As the user draws air through the mouthpiece, the above process repeats itself as needed.

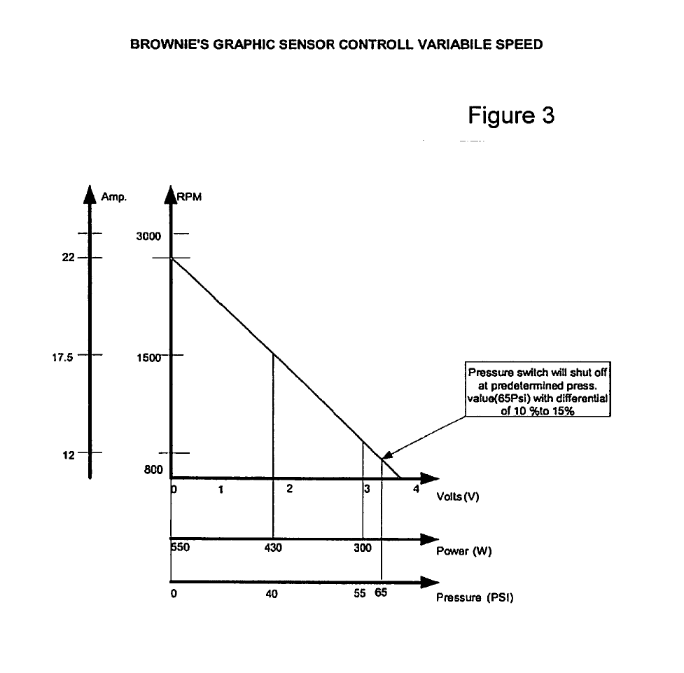

The transducer can work in a large range of pressure and is not limited to the above values, which are used for example purposes only and in connection with the graph shown in FIG. 3. Other values can also be used and are considered within the scope of the invention.

Though two magnets are preferred, other devices, including a magnet and spring (FIG. 5), spring by itself, magnet and a compression spring, hydraulics fluids, magnet and pyrolytic graphite block or plate, and/or other mechanisms which will provide an indication that more air should be produced by the compressor can be used and all are considered within the scope of the invention. Thus, the sensor can be made in multiple ways.

It should also be recognized that the system produces air, as needed, in a dynamic relationship with respect to the inhaling and exhaling of the users, the number of users associated with the system at one time, the underwater breathing experience of the user(s), the lung capacity of the user(s). All of these factors may play a part in the amount of air needed to be produced by the compressor in accordance with the operations of the present invention. Thus, the present invention sensor and system can also be considered as a dynamic sensor/system in addition to its variable characteristics; producing air in the most efficient way.

As seen in FIG. 5, a block electrical diagram of an air-on-demand system 200 which can use a variable dynamic sensor such as, but not limited to, sensor 20 described above. System 200 can also include power propulsion 140 (which can be an electric motor), compressor 150, controller 130, pressure switch 105 and a battery pack 160 similar to like components discussed above. In addition, a fuse 210 and relay 230 can also be included within the electrical schematic for air-on-demand system 200. The operation of air-on-demand system 200 will work similar to the system described above upon the user breathing through his or her mouthpiece and the above description is incorporated by reference in connection with the operation of system 200.

Relay 230, preferably a solid state relay can be provided for ignition protection, and along with delay timer 232 preferably included with the circuitry, is provided as a safety feature. After a period of time, the energy provided by battery 160 will be used up and battery 160 will be dead and need to be changed (or recharged). In the event the user does not turn the overall system on/off switch to the “off” position when replacing battery 160, upon replacement with a “non-dead” battery, an ignition spark can be created if the switch is in the “on” position as the system will take current right away. To prevent, or at least help minimize, the chance of an ignition spark being created, delay 232 prevents the energy from the new battery added to system 200 from being available for a short period of time preferably about 3 seconds to about 5 seconds (i.e. enough time to prevent an ignition spark from occurring). Once the period of time has to be reached, relay 230 closes and the energy from the new battery is available for use. Thus, relay 230, with timer 232, delays the direct start of the system. The delay can be preferably adjustable, and preferably within the range of up to about 5 seconds. However, this range is not considered limiting. Additionally, a preferred delay setting can be 3 seconds, which again is not considered limiting and other values within the above-mentioned preferred range or outside of such range can also be selected and are considered within the scope of the invention.

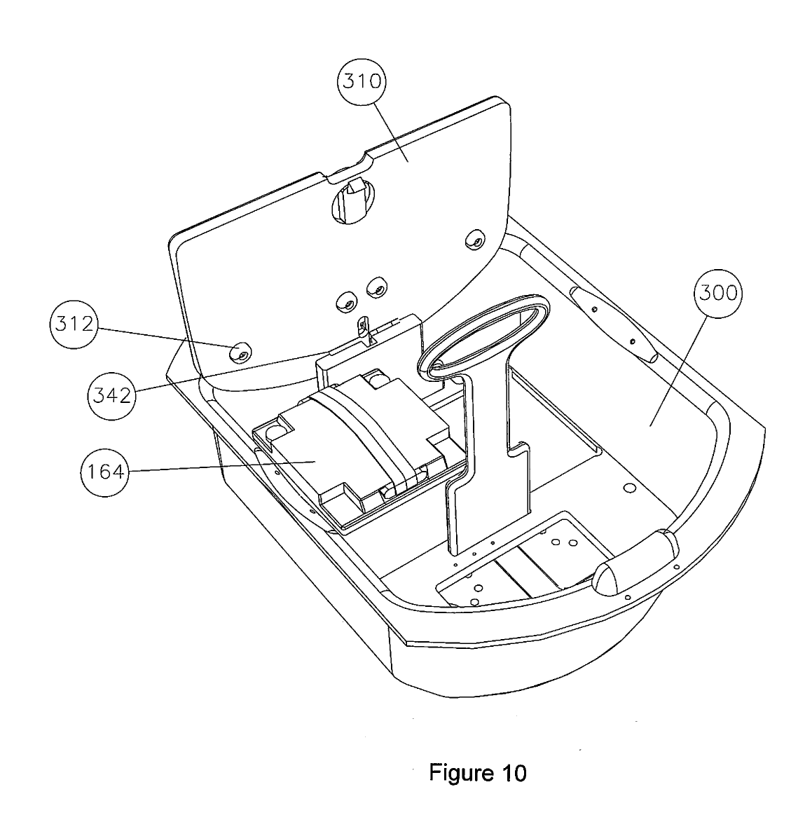

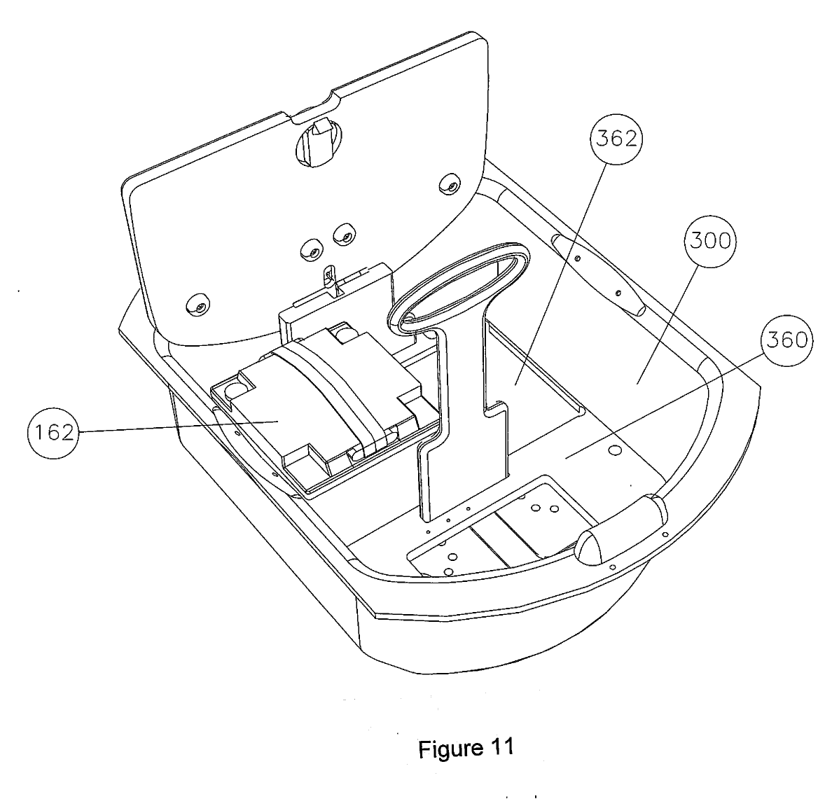

As seen in FIG. 10, an inflatable device, such as, but not limited to an inner tube 400 can be provided and used with the present invention air-on-demand system particularly for floating the air-on-demand system on the surface of a body of water. A lower portion of housing or pan 300 can be sized to fit within aperture 402 defined by inner tube 400 and straps 404 and 402 can be also provided to further secure pan 300 to tube 400.

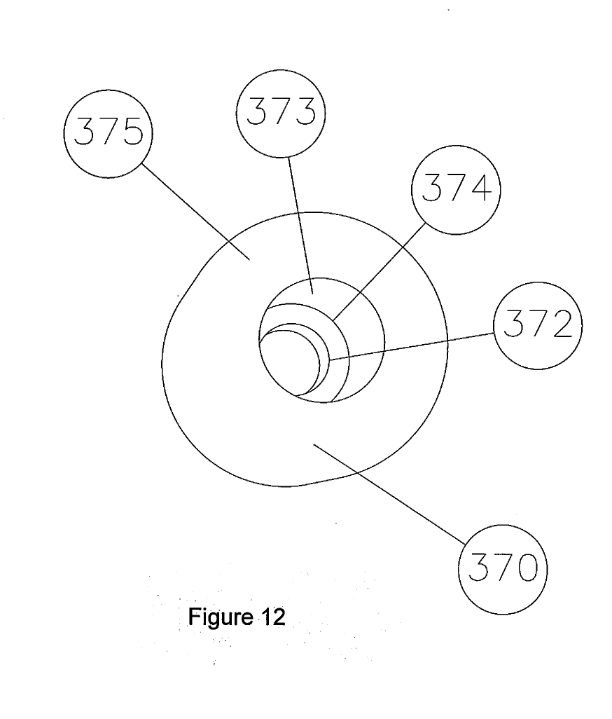

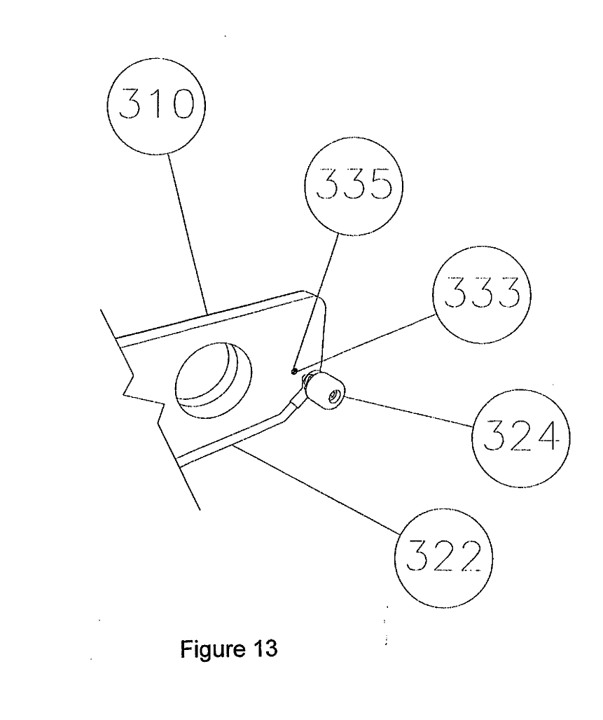

As seen in FIG. 12 a lower tray 360 can also be provided and disposed within pan 300. Tray 360 can include a cutout 362 which defines a battery receiving area.

System 200 is designed such that batteries 162 and 164 can be replaced and removed and connected in series quickly and easily and without the necessity of any tools. As such system 200 makes the battery replacement safe, ergonomically feasible and a tool-free operation.

All measurements, amounts, sizes, shapes, percentages, configurations, securement or attachment mechanisms, sensing members, sealing members, numbers, ranges, frequencies, values, percentages, materials, orientations, methods of manufacture, etc. discussed above or shown in the drawing figures are merely by way of example and are not considered limiting and other measurements, amounts, sizes, shapes, percentages, configurations, securement or attachment mechanisms, sensing members, sealing members, numbers, ranges, frequencies, values, percentages, materials, orientations, methods of manufacture, etc. can be chosen and used and all are considered within the scope of the invention.

Furthermore, one or more features or characteristics discussed for one embodiment of the present invention can also be used with another of the above discussed embodiments of the present invention.

Unless feature(s) or characteristic(s) described in the specification or shown in the drawings for a claim element or claim term specifically appear in the claim with the claim element or claim term, then the inventor does not considered such feature(s) or characteristic(s) to be included for the claim element or claim term in the claim when and if the claim element or claim term is interpreted or construed.

While the invention has been described and disclosed in certain terms and has disclosed certain embodiments or modifications, persons skilled in the art who have acquainted themselves with the invention, will appreciate that it is not necessarily limited by such terms, nor to the specific embodiments and modification disclosed herein. Thus, a wide variety of alternatives, suggested by the teachings herein, can be practiced without departing from the spirit of the invention, and rights to such alternatives are particularly reserved and considered within the scope of the invention.

While the invention has been described and disclosed in certain terms and has disclosed certain embodiments or modifications, persons skilled in the art who have acquainted themselves with the invention, will appreciate that it is not necessarily limited by such terms, nor to the specific embodiments and modification disclosed herein. Thus, a wide variety of alternatives, suggested by the teachings herein, can be practiced without departing from the spirit of the invention, and rights to such alternatives are particularly reserved and considered within the scope of the invention.

What is claimed is:

1. An air on demand breathing system using a dynamic transducer for controlling air, comprising:
a compressor adapted for communication with a breathing mouthpiece through a hose line for supplying air to a user wearing the breathing mouthpiece;
a power propulsion member in communication with the compressor;
a controller in communication with the power propulsion member;
a dynamic transducer in communication with the controller and adapted for communication with the hose line;
a pressure switch in communication with the controller and adapted for communication with the hose line; and
a power source in communication with the controller;
wherein upon a pressure drop within the hose line causing pressure within the hose line to reach a threshold level as determined by said pressure switch a signal is sent to the controller to turn “on” the power propulsion member which causes the compressor to provide more air within the hose line wherein once the pressure switch learns that pressure within the hose line is no longer at or beyond threshold level the controller turns “off” the power propulsion member;
wherein said dynamic transducer provides information to the controller as to what speed the power propulsion member should be operated while the power propulsion member is “on” based on the amount of air removed from the hose line.

2. The air on demand breathing system of claim 1 wherein said power source is one or more batteries.

3. The air on demand breathing system of claim 1 wherein said dynamic transducer is a variable speed Hall effect magnetic sensor.

4. The air on demand breathing system of claim 1 wherein said power propulsion member is an electric motor.

5. The air on demand breathing system of claim 2 further comprising a delay timer and relay in electrical communication with said one or more batteries and said controller and electrically disposed between said one or more batteries and said controller.

6. The air on demand breathing system of claim 5 further comprising a fuse electrically disposed between said one or more batteries and said controller.

7. The air on demand breathing system of claim 5 further comprising a fuse electrically disposed between said one or more batteries and said delay timer.

8. An air on demand breathing system using a dynamic transducer for controlling air, comprising:
a compressor for producing air and adapted for communication with a breathing mouthpiece through a hose line in order to supply within the hose line for use by a user wearing the breathing mouthpiece;
an electric motor in electrical communication with the compressor;
a controller in electrical communication with the power propulsion member;
a variable speed Hall effect magnetic sensor in communication with the controller and adapted for communication with the hose line;
a pressure switch in communication with the controller and adapted for communication with the hose line; and
a battery pack in communication with the controller;
wherein upon a pressure drop within the hose line causing pressure within the hose line to reach a threshold level as determined by said pressure switch a signal is sent to the controller to turn “on” the electric motor member which causes the compressor to provide more air within the hose line wherein once the pressure switch learns that the pressure within the hose line is no longer at or beyond the threshold level the controller turns “off” the power propulsion member;
wherein said variable speed Hall effect magnetic sensor provides information to the controller as to what speed the electric motor should be operated while the electric motor is “on” based on the amount of air removed from the hose line.

9. The air on demand breathing system of claim 8 wherein said battery pack is one or more batteries.

10. The air on demand breathing system of claim 8 further comprising a delay timer and relay in electrical communication with said battery pack and said controller and electrically disposed between said battery pack and said controller.

11. The air on demand breathing system of claim 8 further comprising a fuse electrically disposed between said battery pack and said controller.

12. The air on demand breathing system of claim 10 further comprising a fuse electrically disposed between said battery pack and said delay timer.

13. A battery assembly for supplying power to an item, comprising a first battery having a first positive terminal and a first negative terminal;
a second battery having a second positive terminal and a second negative terminal;
a manifold having a top surface and a bottom surface; and
a battery series connecting assembly secured to the bottom surface of said manifold;
wherein in use said manifold is positioned over said first battery and said second battery such that the battery series connected assembly makes contacts with the first positive terminal, the first negative terminal, the second positive terminal and the second negative terminal such that the first battery and the second battery are connected in series to each other.

14. The battery assembly for supplying power to an item of claim 13 wherein said battery series connecting assembly comprising:
a first terminal contact;
a second terminal contact;
a third terminal contact;
a fourth terminal contact;
a positive wiring providing electrical communication between said fourth terminal contact and with an item to receive power from said first battery and said second battery;
a negative wiring providing electrical communication between said first terminal contact and with the item;
a series wiring providing electrical communication between said second terminal contact and said third terminal contact;
wherein in use with the manifold disposed over the first battery and the second battery the terminal contacts come into contact with the battery terminals which causes the first battery and the second battery to be connected in series.

16. The battery assembly for supplying power to an item of claim 13 wherein said first battery is a 12V battery and said second battery is a 12V battery.

17. The battery assembly for supplying power to an item of claim 13 further comprising a first removable handle secured to said first battery.

18. The battery assembly for supplying power to an item of claim 17 wherein said first removable handle comprising a first substantially rigid member, a second substantially rigid member and a strap, said first substantially rigid member secured at a first end of said strap and said second substantially rigid member secured at a second end of said strap.

19. The battery assembly for supplying power to an item of claim 18 wherein a top area of said battery having a first opening and a second opening, wherein said first substantially rigid member disposed within the first opening and said second substantially rigid member disposed within the second opening.

20. The battery assembly for supplying power to an item of claim 17 further comprising a second removable handle secured to said second battery.
